(19) United States
(12) Patent Application Publication
(10) Pub. No.: US 2025/0010443 A1
(43) Pub. Date: Jan. 9, 2025

(54) METHODS AND APPARATUSES FOR ENGAGING A PRESS-IN BOTTLE ADAPTER FROM A BOTTLE

(71) Applicant: Express Scripts Strategic Development, Inc., St. Louis, MO (US)

(72) Inventors: Andrew J. Seiffert, O'Fallon, MO (US); Ken Bast, St. Louis, MO (US)

(21) Appl. No.: 18/764,816

(22) Filed: Jul. 5, 2024

Related U.S. Application Data
(60) Provisional application No. 63/525,445, filed on Jul. 7, 2023.

(51) Int. Cl. B25B 27/04; B25B 27/02

(52) U.S. Cl. CPC B25B 27/04; B25B 27/023

(57) ABSTRACT

A removal tool including a key. The key including an actuator including a handle. The handle extending a first direction. The key also including a protrusion defining a plurality of threads. The protrusion coupled with the actuator. The protrusion extending a second direction away from the handle. The first direction is non-parallel with the second direction. The removal tool also includes a removable cap defining an aperture centrally located therein. The removable cap is configured to operably couple with a neck of a bottle.

### CROSS-REFERENCE TO RELATED APPLICATION

This application claims priority to and the benefit of U.S. Provisional Application No. 63/525,445, filed on Jul. 7, 2023, and entitled “METHODS AND APPARATUSES FOR REMOVING A PRESS IN BOTTLE ADAPTER FROM A BOTTLE,” the entire contents of which is herein incorporated by reference.

### TECHNICAL FIELD

Embodiments of the subject matter described herein relate generally to handling a liquid-containing bottle having a press-in bottle adapter in a home, provider, or pharmacy environment. More particularly, embodiments of the subject matter relate to the removal of a press-in bottle adapter for a liquid-medicine-containing bottle.

### BACKGROUND

Bottles containing liquids may sometimes require a press-in bottle adapter (PIBA) to assist in sealing liquids in the bottle while allowing extraction of liquids. More specifically, the primary function of a PIBA is to control the flow of the liquid medication from an interior of the bottle directly into a syringe, dropper, or any other suitable measuring device without spilling or contaminating the liquid medication.

A PIBA is typically installed into a bottle by a pharmacist in a pharmacy such that the customer receives the bottle with the PIBA already installed into an opening of the bottle. In some other cases, the customer can install the PIBA into the opening of the bottle on their own. However, due to the tight fit relationship between the PIBA and the bottle that is necessary to adequately seal the PIBA against the bottle, installation can be difficult.

### SUMMARY

One aspect of the present disclosure is related to an apparatus for a bottle containing a liquid, e.g., liquid medicine. The apparatus includes a removal tool including a removable cap that is configured to be coupled with the bottle. The removable cap has an aperture that extends through it. The apparatus also includes a key with an actuator. The actuator has a breaker that selectively engages with the removable cap. The actuator also has a first side extension that is coupled with the breaker. The actuator can further include a second side extension that is spaced from the first side extension and is also coupled with the breaker. A handle is coupled with the first side extension and the second side extension, and the first and second side extensions space the breaker from the handle. A protrusion is coupled with the breaker and includes at least one radially outward projection. The protrusion extends through the aperture of the removable cap. The removable cap can be separate from the manufacturer's cap. The press-in bottle adapter includes a stopper with an internal wall that defines a cavity which is configured to catch the protrusion of the key. The projection of the protrusion engages the internal wall to interlink the protrusion and the stopper. The press-in bottle adapter further includes an elongate tubular member that is coupled with the stopper and extends therefrom into the bottle.

According to another aspect of the present disclosure, the apparatus further includes an insertion tool that is configured to install a press-in bottle adapter into the bottle. The insertion tool includes a housing that has a through passage and that is configured to be engaged with the bottle. The insertion tool also includes a plunger that is at least partially received within the through passage of the housing and is configured to move relative to the housing and to press the press-in bottle adapter into the bottle.

According to yet another aspect of the present disclosure, the radially outward projection includes a plurality of threads that are oriented non-parallel with the breaker such that the actuator rotates about a central axis of the protrusion to drive the protrusion into the cavity of the stopper.

According to still another aspect of the present disclosure, the plurality of threads or the projection permanently deform the internal wall of the stopper such that the internal wall defines a plurality of complimentary recesses that interlock between the plurality of threads or the projection, respectively.

According to a further aspect of the present disclosure, the removable cap defines a funneled surface leading to the aperture.

According to yet a further aspect of the present disclosure, the radially outward projection includes a plurality of threads that are oriented parallel with the breaker such that the actuator is translated toward the stopper to drive the protrusion through the aperture of the removable cap into the cavity of the stopper.

According to still a further aspect of the present disclosure, the radially outward projection includes a plurality of barbs, hooks or other individualized means to interlock with the press-in bottle adapter.

According to another aspect of the present disclosure, the breaker has a first width, the handle has a second width, and the removable cap has a third width. The first width is greater than the third width, and the second width is greater than the third width.

According to yet another aspect of the present disclosure, the protrusion has a first length, the removable cap at the aperture has a thickness, and the cavity has a first depth. The stopper is spaced from the aperture by a second depth. The sum of first thickness, the first depth, and the second depth are substantially equal to the first length.

According to still another aspect of the present disclosure, the protrusion has a first cross-sectional area large enough to be substantially flush with the removable cap within the aperture such that the removable cap with the protrusion disposed within the aperture of the removable cap is substantially leak resistant.

According to a further aspect of the present disclosure, the actuator is rotated and translated manually.

Another aspect of the present disclosure is related to a method that includes the step of decoupling a manufactured cap from a neck of a bottle. The method continues with the step of coupling a removable cap defining an aperture with the neck of the bottle. The method proceeds with the step of inserting a protrusion of a key into the aperture of the removable cap. The method continues with the step of driving an actuator of the key toward a press-in bottle adapter until a breaker of the key engages the removable cap. The method proceeds with the step of defining a coupled relationship between the protrusion and the stopper within a cavity of the stopper. The method continues with the step of displacing the actuator of the key away from the removable cap until the press-in bottle adapter is essentially decoupled from the neck of the bottle. The method proceeds with the step of decoupling the removable cap from the neck of the bottle to remove the press-in bottle adapter and the removable cap from the bottle.

According to another aspect of the present disclosure, the key has a first modulus of elasticity and the press-in bottle adapter has a second modulus of elasticity. The first modulus of elasticity is greater than the second modulus of elasticity.

According to yet another aspect of the present disclosure, prior to defining the coupled relationship, the method proceeds with the step of rotating the actuator of the key. The method proceeds with the step of deforming an internal wall of the stopper within the cavity with a radially outward projection of the protrusion to define a first plurality of complimentary recesses.

According to still another aspect of the present disclosure, prior to decoupling the removable cap from the neck of the bottle, the method includes the step of displacing the actuator of the key away from the removable cap until the press-in bottle adapter fixed with the key at least partially moves from within the neck of the bottle into the removable cap.

According to a further aspect of the present disclosure, the method further includes the step of driving the actuator of the key toward the cavity of the stopper until the protrusion having a first depth extends into the cavity a distance substantially equal to a second depth of the cavity.

According to yet a further aspect of the present disclosure, the method further includes the step of installing a new press-in bottle adapter into the neck of the bottle with an insertion tool. The method continues with the step of inserting the new press-in bottle adapter into a through passage of a housing of the insertion tool. The method proceeds with the step of coupling a housing of the insertion tool with the neck of the bottle. The method continues with the step of displacing a plunger of the insertion tool to urge the new press-in bottle adapter into the neck of the bottle.

Yet another aspect of the present disclosure is related to an apparatus that includes a removal tool with a key. The key includes an actuator that has a handle. The handle extends a first direction. The handle also includes a protrusion that defines a plurality of threads. The protrusion is coupled with the actuator and extends in a second direction away from the handle. The first direction is non-parallel with the second direction. The key also includes a removable cap that defines an aperture centrally located therein. The removable cap is configured to operably couple with a neck of a bottle.

According to another aspect of the present disclosure, an internal depth of the removable cap is at least equal to a neck height of the neck of the bottle configured to be operably coupled with the removable cap and a stopper height of a stopper of a press-in bottle adapter configured to be removed by the removal tool.

According to yet another aspect of the present disclosure, the actuator further includes a first side extension coupled with the handle. The first side extension extends outwardly from the handle. The actuator also includes a second side extension that is coupled with the handle distal the first side extension. The second side extension extends outwardly from the handle. The first side extension and the second side extension are engaged by at least one of a user and an electric motor to apply a torque to the key.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is an exploded view of a removal tool, a press-in bottle adapter, and a bottle;

FIG. 2A is a top, side view of a removable cap;

FIG. 2B is a bottom, side view of the removable cap;

FIG. 3A is a side view of a key having an actuator including a handle, a breaker, and a plurality of side extensions according to an example embodiment;

FIG. 3B is a side view of a key having an actuator according to a further example embodiment;

FIG. 3C is a bottom view of a key having an actuator coupled with a disc according to a further example embodiment;

FIG. 4A is side view of the removable cap coupled with the bottle;

FIG. 4B is a cross-sectional view taken generally along line A-A of FIG. 4A including the key of FIG. 3A;

FIG. 5A is a side view the key inserted through the removable cap;

FIG. 5B is a cross-sectional view taken generally along line B-B of FIG. 5A;

FIG. 6A is a side view the key having essentially decoupled the press-in bottle adapter from the bottle;

FIG. 6B is a cross-sectional view taken generally along line B-B of FIG. 5A;

FIG. 7 is a perspective view of the removal tool and press-in bottle adapter interlinked and separated from the bottle;

FIG. 8 is a block diagram of an example system according to an example embodiment;

FIG. 9 is a block diagram of an example order processing device that may be deployed within the system of FIG. 8;

FIG. 10 is a side view of a key having an actuator including a handle, a breaker, and a plurality of side extensions and a protrusion according to another example embodiment;

FIG. 11 is a side view of a key having an actuator including a handle, a breaker, and a plurality of side extensions and a protrusion according to yet another example embodiment;

FIG. 12 is a perspective view of an example embodiment of a press-in bottle adapter insertion tool;

FIG. 13 is a cross-sectional view of the example embodiment of the press-in bottle adapter insertion tool;

FIG. 14 is a cross-sectional view of the example embodiment of the press-in bottle adapter at a beginning of a press-in bottle adapter insertion operation; and

FIG. 15 is a cross-sectional view of the example embodiment of the press-in bottle adapter after a press-in bottle adapter insertion operation is completed.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

In one example scenario, a liquid-containing bottle may include a PIBA having a straw that extends into the internal volume of the bottle. Examples of this type of PIBA may be for a chemical substance that includes pharmaceuticals, which are often are administered from an upright-bottle in specific dosages. In some situations, a pharmaceutical substance (i.e., drug, medicine) may require the liquid-containing bottle having a PIBA to be discarded or sent back to a pharmacy if the assembly of the liquid-containing bottle and PIBA does not function as intended by the pharmacy.

Accordingly, it is desirable to implement elegant methods and apparatuses to remove a PIBA that does not function as intended by the manufacturer. Furthermore, other desirable features and characteristics will become apparent from the subsequent detailed description and the appended claims, taken in conjunction with the accompanying drawings and the foregoing technical field and background.

The subject matter presented herein relates to systems, apparatus, and methods for the removing of a PIBA from a liquid-containing bottle. More specifically, the subject matter relates to removing a PIBA having an elongated tubular member from a liquid medicine-containing bottle. An example PIBA is described in US Patent Publication No. 2010/0327010 A1, which is hereby incorporated by reference. However, if this US Patent Publication conflicts with the present disclosure, the present disclosure controls. A PIBA is pressed into the neck of a bottle to and is configured to receive a syringe or other medication dispensing device. The PIBA has a distal end that is positioned in the neck of the bottle, and a normally closed valve (i.e., a one-way valve) is located at that distal end to prevent the liquid from leaking past the PIBA and out of the bottle, even if the bottle is tipped over or inverted. The PIBA can have a plurality of axially spaced apart flanges that press and are in a fluid tight sealing relationship with an interior surface of the bottle neck.

In an example, the PIBA has an upper flange that is seated against a top of the bottle and recessed into the neck below the top of the bottle to prevent easy access and to make it difficult for a user to pry the PIBA out of the bottle. In an example, the upper flange is made of a different material that is stiffer than one or more of the other, lower flanges. The plurality of flanges makes removal of the PIBA from the bottle with only common household tools very difficult and attempting to do so can result in spillage of the contents of the bottle. In an example, the PIBA can have top most flange that is more rigid than at least one flange below the top most flange.

A bottle cap can engage the neck of the bottle around the PIBA to open and close the bottle with the PIBA remaining in the bottle neck. The bottle cap can have internal threads that thread onto external threads on the outer surface of the neck. The cap in its open position allows access to the PIBA and bottle contents by a syringe or other specialized mechanical means. N an example, the underside of the cap can contact the PIBA, e.g., at or adjacent the top flange, to force the PIBA into the neck at or below the top, annular surface of the neck of the bottle.

Certain terminologies are used with regard to the various embodiments of the present disclosure. For purposes of the present disclosure, the term “essentially decouple” indicates a PIBA that was originally coupled with a bottle during a manufacturing or a preparation process has become decoupled therefrom. Further, the phrase “essentially decouple” also means that the PIBA becomes no longer flush inside a neck of the bottle or no longer fluidly seals the liquid within the bottle. In a further example, the term “essentially decouple” can mean that at least the uppermost flange is unsealed from the interior of the neck. The uppermost flange can extend above the top of the bottle neck. However, “essentially decouple” does not necessarily mean the PIBA is spaced from the bottle or the neck of the bottle. In other words, if a liquid inside an internal volume of the bottle could pass between the PIBA and the neck of the bottle after the PIBA, then the PIBA is essentially decoupled from the bottle. Liquids may refer to pharmaceuticals (e.g., drugs, medicines and the like), liquid dietary supplements, cosmetics, cleaners, drinkable food items, chemical fluids, industrial chemicals, or any other liquid which may be extracted from a bottle though a PIBA in fluid communication with the internal volume of a liquid-containing bottle.

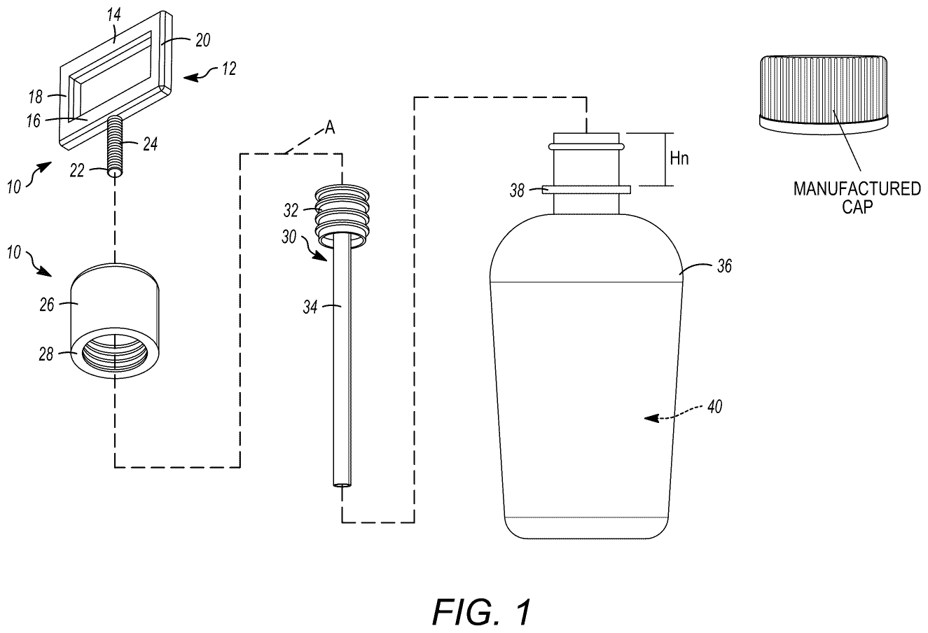

Turning now to the figures, FIG. 1 is an exploded view of a diagram of a removal tool 10 and a container or bottle 36, in accordance with one or more of the disclosed embodiments. The bottle 36 can include a manufacturer's cap. The removal tool 10 is generally used to remove a PIBA 30 from a container. The bottle 36 may be of a polymeric material, a glass material, a metallic material, or any suitable liquid containing material, for example. The bottle may be semi-transparent. The removal tool 10 may be of a polymeric material, a glass material, or a metallic material, for example. The opacity of the removal tool 10 can range between transparent and opaque, for example. For example, the removal tool 10 that is at least semi-transparent can provide views through the removal tool 10 such that one can see the PIBA 30 through the removal tool 10. Further, the container may be a bottle 36, for purposes of decreasing waste and repackaging the liquid-containing bottle for distribution or other applications, as needed. The bottle 36 is a liquid-containing bottle in an example embodiment.

In some cases, a defective PIBA 30 can prevent access to the liquid in the bottle 36, i.e., the PIBA 30 must be removed to access the bottle contents or may not seal the liquid in the bottle 36. As disclosed herein, the removal tool 10 allows a defective PIBA 30 to be removed and replaced with a new replacement PIBA, thereby decreasing the amount of liquid-containing bottles 36 that would be discarded, destroyed, or repackaged for re-distribution. Benefits of using the removal tool 10 for removing the PIBA 30 from the liquid-containing bottle 36 may include, but are not limited to, cost-savings due to having a customer remove the PIBA 30 without the need to discard or send the bottle 36 back, thereby increasing efficiency in a customer environment, e.g., access to medication or other bottle content in the desired manner through the PIBA. The removal tool 10 also allows for reduced waste, the prevention of expiration of liquids within the bottle, and the like. These cost savings are especially beneficial to the customer and the distributor when the liquid contained within an internal volume 40 of the bottle 36 cost hundreds or thousands of United States dollars, or more.

As disclosed herein, PIBAs 30 for which the removal tool 10 can be used may include any type of PIBA 30 that is configured to seal the bottle 30 other than from designated use of a liquid suction device, e.g., a syringe, a tube, a pipe or the like. Exemplary embodiments of PIBAs 30 may include, without limitation: any type of PIBA 30 having an elongate tubular member 34 extending from a main body, e.g., a stopper 32. The stopper 32, as illustrated in FIGS. 1, 4B, 5B, and 6B, engages the inside of the neck 38 of the bottle 36. The stopper 32 is frictionally coupled with the inside of the neck 38 of the bottle 36. In an example, the stopper is press fit to the inner wall of the neck 38. As shown in FIGS. 1, and 4A-7, the neck 38 of the bottle 36 is cylindrical. In another example, the neck may have a straight side or be a parallelepiped. The stopper 32 has a complementary geometry of the neck 38 to assist in frictionally coupling therein. The stopper 32 also extends into the neck 38 of the bottle 36 a distance that is approximately a full height Hn of the neck 38. The complementary geometry of the stopper 32 has a complementary cross-sectional area, when in an unstressed condition, that is larger than a neck cross-sectional area of an interior of the neck 38. The stopper's 32 larger complementary cross-sectional area, along with its elasticity, allows the stopper 32 to be press fit into the neck 38 of the bottle 36 and provide a liquid seal once mounted in the interior volume defined by the neck 38. In an example with the neck 38 having a cylindrical neck portion to receive the PIBA 30, the plurality of flanges of the stopper 32 have a larger circumference than an internal neck circumference of the neck 38.

Integrity of the liquid-containing bottle 36 remains intact during and after use of the removal tool 10, and such that the liquid-containing bottle 36 and removal tool 10 permits minimal to no losses of the liquid within the liquid-containing bottle 36. The removal tool 10 operates most efficiently with the bottle 36 containing low to medium viscosity liquids, although in some embodiments, high viscosity liquids may be used.

Exemplary embodiments of the removal tool 10 may be used in a customer's home environment to remove a PIBA 30 from a liquid-containing bottle 36 without having to re-package and return the liquid-containing bottle 36 to the distributor. However, it should be appreciated that other embodiments of the removal tool 10 may be used for removing the PIBA 30, as required for a desired application, such as a pharmacy, chemistry lab, fabrication that use liquids, or other uses described herein.

The removal tool 10 may include, without limitation: an assembly of a key 12 and a removable cap 26 that is adapted to threadedly engage with external threads on the liquid-containing bottle 36. More specifically, the removable cap 26 is configured to couple with a neck 38 of the liquid-containing bottle 30. The key 12 is a rigid instrument that is configured to engage the PIBA 30 and removable cap 26 to facilitate the removal of the PIBA 30 from the container 36 in a manner described below. In an example embodiment, the cap 26 is removably engaged to the bottle 30, e.g., by threadedly engaging, press-fitting, or the like. It should be appreciated that FIG. 1 depicts a simplified embodiment of the removal tool 10, the PIBA 30, and the liquid-containing bottle 36 (e.g., for ease of explanation), and that some implementations of the removal tool 10 may include additional elements or additional components, as desired for the particular application. For example, additional components such as motors, electronics, computing devices, displays, mechanical arms, and/or user input components may be employed without departing from the scope of the present disclosure.

The removal tool 10 is an operative piece of hardware. Some embodiments of the removal tool 10 may be made of, or include, metallic materials. Other embodiments may be molded of or 3D printed of pharmaceutical grade polymers, plastic or other polymeric materials. It should be appreciated that the removal tool 10 may require washing, disinfecting, or replacing between uses and/or according to another event-driven or time-driven schedule. In an example, the removal tool 10 is a single use device that may become fixed to the PIBA 30 once the PIBA 30 is removed from the bottle 36 or the removal tool 10 is disengaged from the bottle 36. In an example, the removal tool 10 is a single use device that self-destructs once the PIBA 30 is removed from the bottle 36 or the removal tool 10 is disengaged from the bottle 36. Self destruction means that the removal tool and or the PIBA cannot be reused to remove another PIBA or the removed PIBA cannot be used to seal another bottle 36. Additionally, or alternatively, the removal tool 10, with or without the removed PIBA, is sent back to the distributor. In an example embodiment, the removal tool 10 is packaged with a return shipping container such that the removal tool 10 and/or the removed PIBA 30 are returned to the shipper, e.g., a pharmacy or pharmacy benefits manager. In another example embodiment, the removal 10 degrades after one or more uses to prevent future long-term and repeated use. The material of the removal tool 10 can be selected such that it is inert with respect to the liquid being containing in the bottle 36. Further, the material of the removable tool 10 has a first modulus of elasticity. The material of the PIBA 30 has second modulus of elasticity. The first modulus of elasticity is greater than the second modulus of elasticity. In an example, the first modulus of elasticity is at least twice the second modulus of elasticity. In an example, the first modulus of elasticity is at least an order of magnitude greater than the second modulus of elasticity. In other words, the removal tool 10 is made of a less elastic material than the PIBA 30.

Exemplary embodiments of the key 12 are described below with regard to FIGS. 1-7. As described herein, the key 12 includes a protrusion 22 that is coupled with an actuator 48. The protrusion 22 may also be referred to as a bit, for example. As depicted in FIGS. 1-7, the protrusion 22 is centrally coupled with the actuator 48; however, it is contemplated that the protrusion 22 may be coupled asymmetrically with the actuator 48, e.g., on a lateral side of the actuator 48 to provide for a larger rotational arm about a central axis A that extends through the protrusion 22. The protrusion 22 can be an elongate rod or shaft that has a lateral dimension (e.g., width or diameter) that is small enough to extend through an aperture in the removable cap 26 (shorter than lateral dimension of aperture in cap 26) and large enough to mechanically engage the central recess in the PIBA 30 (larger than lateral dimension of central aperture in PIBA 30). The protrusion 22 may, for example, be circular, oval, polyhedron, and rectangular in cross section. The protrusion 22 is four times longer than its lateral dimension in an example. As an example of self-destruction of the removal tool 10, degradation of the removal tool 10 could include, for example, the protrusion 22 separating from the key 12 after removal of the PIBA 30.

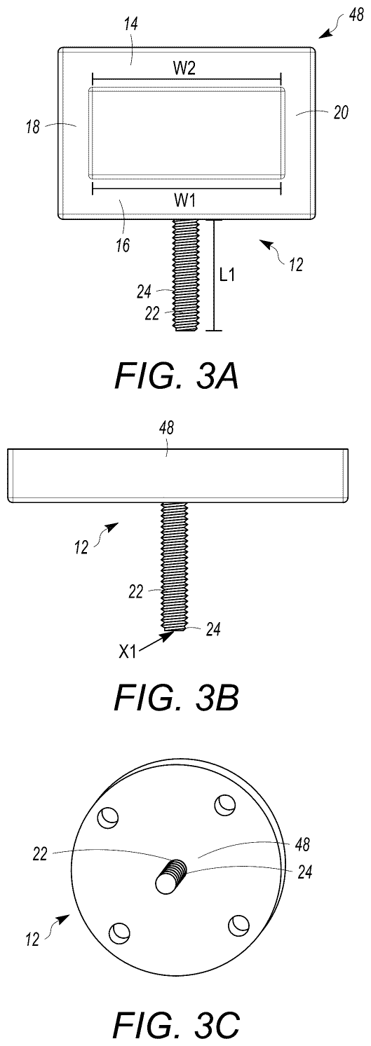

With particular reference to FIG. 3A, the actuator 48 may include a breaker 16 that is directly coupled with the protrusion 22. In an example embodiment, the actuator 48 is fixed to the protrusion 22. The protrusion 22 may be integrally formed with the actuator 48 to form a unitary body. The actuator 48 may also be referred to as a bow or a head, for example. The protrusion 22 extends orthogonally relative to the breaker 16. The breaker 16 has a first width W1. The width W1 of the breaker 16 is such that a user may grasp and rotate the key 12 by hand without additional tools. The breaker 16 may be prismatic in geometry, e.g., a rectangular polyhedron or rectangular prism. Additionally, or alternatively, the breaker 16 may be cylindrical or ovoid in geometry (e.g., a toroid, torus or the like). The central axis of the protrusion 22 is positioned at the center of the breaker 16, e.g., at half the dimension W1. The breaker 16 operates as a breaker bar to increase torque applied to the protrusion 22 due to the breaker 16 having greater width (e.g., W1 or W1 plus the width of side extensions) than the lateral dimension of the protrusion 22.

With further reference to FIG. 3A, the actuator 48 may include a first side extension 18 that is coupled with the breaker 16. As shown, the in the exemplary embodiment, the first side extension 18 is coupled with a first lateral end of the breaker 16. The actuator 48 also includes a second side extension 20 that is coupled with the breaker 16 at a second lateral end thereof. The breaker 16 extends between the first side extension 18 and the second side extension 20. The first side extension 18 may be prismatic in geometry, e.g., a rectangular polyhedron. Additionally, or alternatively, the first side extension 18 may be cylindrical or ovoid in geometry. The second side extension 20 may be prismatic in geometry. Additionally, or alternatively, the second side extension 20 may be cylindrical in geometry. As shown, the first side extension 18 mirrors the second side extension 20 such that the second side extension 20 is coupled with the other lateral end of the breaker 16. The first side extension 18 and the second side extension 20 may be engaged by the hand of the user or a rotational prime mover to promote rotation of the key 12 about the central axis A. The central axis A extends along the longitudinal axis of the protrusion 22. In use, the first and second side extensions 18, 20 extend vertically with or parallel to the longitudinal axis of the bottle 36 or the PIBA 30.

With further reference to FIG. 3A, the actuator 48 may include a handle 14 coupled with the first side extension 18 and the second side extension 20. The handle 14 is spaced from the breaker 16 by the first side extension 18 and the second side extension 20. The handle 14 has a second width W2. As shown, the second width W2 may be substantially equal to the first width W1. Substantially equal in this context means that the overall portrait of the actuator 48 is a parallelogram. Additionally, or alternatively, W1 and W1 may be different such that the overall portrait of the actuator 48 is a trapezoid. The handle 14 may be prismatic in geometry, e.g., a rectangular polyhedron. Additionally, or alternatively, the handle 14 may be cylindrical or oval in geometry. Further, the respective geometries of the breaker 16, the first side extension 18, the second side extension 20, and the handle 14 may be of a same or similar nature, e.g., all ovoid or all rectangular polyhedrons. Alternatively, the respective geometries of the breaker 16, the first side extension 18, the second side extension 20, and the handle 14 may be of a different nature, e.g., some rectangular polyhedrons and some circular. The first side extension 18 may be spaced from the second side extension 20, and the handle 14 may be spaced from the breaker 16 such that the actuator 48 may have an opening that is shaped and sized to receive between one finger and all fingers of the hand of the user to promote ergonomics while grasping the actuator 48 during removal of the PIBA 30.

With further reference to FIGS. 13A-3B, the actuator 48 includes the protrusion 22. The protrusion 22 is coupled with the actuator 48, is elongate, and extends downwardly (in use) therefrom. Additionally, or alternatively, the protrusion 22 is directly coupled with the breaker 16 of the actuator 48 and extends downwardly therefrom. The protrusion 22 has a length L1.

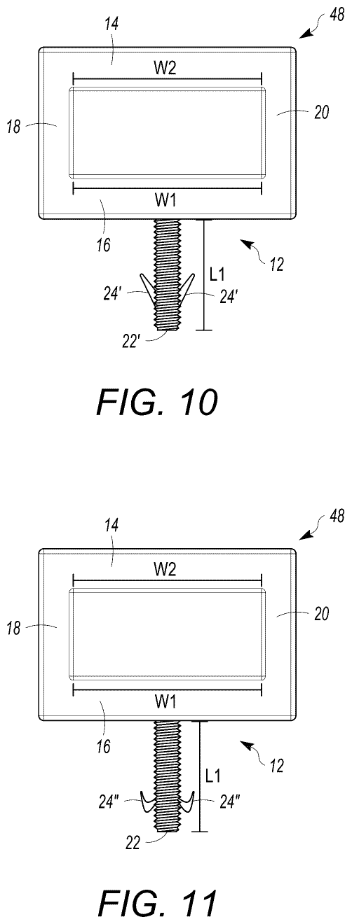

With even further reference to FIGS. 3A-3B, the protrusion 22 includes a plurality of PIBA engagement mechanisms, e.g., threads 24. In this context, the plurality of threads 24 may be continuous along the entire length L1 of the protrusion 22, as shown. In an example, the threads 24 are a continuous helical rib extending radially outwardly from the shank surface of the protrusion. Additionally, or alternatively, the plurality of threads 24 may be non-continuous (i.e., partially circumscribing the protrusion 22). Additionally, or alternatively, the plurality of threads 24 may be non-parallel with the breaker 16 such that the plurality of threads 24 are inclined from a portrait or profile view of the protrusion 22. Additionally, or alternatively, the plurality of threads 24 may be parallel with the breaker 16 from a profile or portrait view of the protrusion 22. Further, the plurality of threads 24 may be barb shaped or include barbs (see the barbs 24′ or 24″ illustrated in FIGS. 10 and 11 respectively) such that in use, the protrusion 22 is translated downwardly with more ease than the protrusion 22 is translated upwardly. Even further, the plurality of threads 24 may be a right angle relative to the outer surface of the shank of the protrusion 22. The threads 24 may be angled upwardly allowing the protrusion 22 to slide into a cavity 46 of the PIBA 30 and to aggressively bite into the material of the PIBA 30 when the actuator 48 of the key 12 is pulled upwardly. The protrusion 22 has a cross-sectional area X1. Further, one more example of self-destruction of the removal tool 10 could include degradation of the plurality of threads 24.

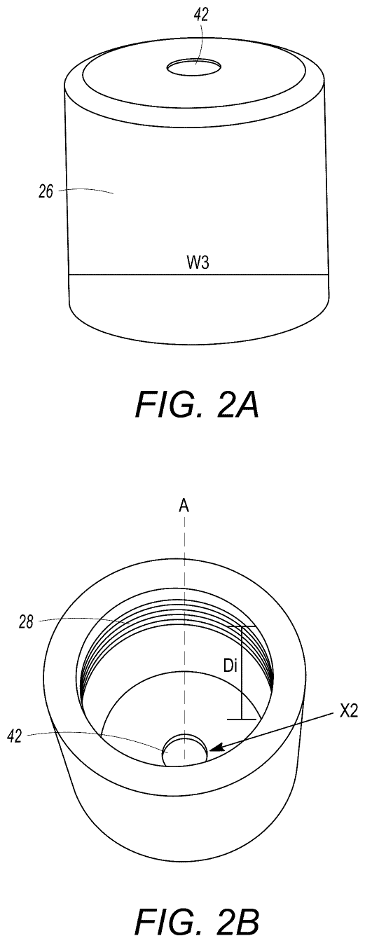

With reference to FIGS. 2A-2B and 4A-6B, the removal tool 10 includes the removable cap 26. The removable cap 26 defines an aperture 42 centrally located therein from a plan view (i.e., top view). In use, the aperture 42 aligns with the central axis, A. The aperture 42 is configured to receive the protrusion 22. The cross-sectional area, X1, of the protrusion 22 is substantially flush with the removable cap while the protrusion 22 is disposed within the aperture 42 of the removable cap 26 such that the removable cap 26 with the protrusion 16 disposed within the aperture 42 of the removable cap 26 is substantially leak resistant. In this context, substantially leak resistant means that in use, there are minimal to no losses of the liquid from within the internal volume of the bottle 36. The removable cap 26 relates to a manufactured cap in that both the removable cap 26 and the manufactured cap are of the same third width W3. The removable cap 26 and the manufactured cap may both include similar internal threading 28 to twistably coupled with the neck 38 of the bottle 36. Both the removable cap 26 and the manufactured cap are substantially leak resistant between the neck 38 and the internal threading 28. However, the removable cap 26 and the manufactured cap differ in that the removable cap has an internal depth Di. Meanwhile, the manufactured cap has an internal depth that is less than Di. For example, the internal depth Di may be about 150% the internal depth of the manufactured cap. The manufactured cap engages the top of the neck 38 when fully coupled with the neck 38 of the bottle 36. In contrast, when fully coupled, the removable cap 26 at the aperture 42 is spaced from the top of the neck 38 by a second depth D2.

With further reference to FIGS. 2A-2B and 4A-6B, the removable cap 26 may be considered a guide because the aperture 42 aligns with the cavity 46 at the central axis A. The protrusion 22 that is inserted through the aperture 42 or the removable cap 26, or guide, is aligned with the cavity 46. The guide may differ from the removable cap 26 in that the guide may not be as substantially leak resistant as the removable cap 26. Further the guide, the removable cap 26, may include a seal ring coupled with the guide or removable cap 26 within the aperture 42. The seal ring would increase the leak resistant properties of the removal tool 10 while the protrusion 22 of the key 12 is disposed through the aperture 42. The seal ring may be made of a softer polymeric material than the key 12 and the removable cap 26, for example. Additionally, or alternatively, the seal ring may be made from a rubber or rubber-like, material for example.

With further reference to FIGS. 2A-2B and 4A-6B, the removable cap 26 has the third width W3. The third W3 of the removable cap 26 is less than the first and second widths W1, W2 of the breaker 16 and the handle 48 respectively. The removable cap 26 at the aperture 42 has a first thickness, T. The removable cap 26 has the internal depth, Di. Di is greater than or equal to a height Hn of the neck 38 of the bottle 36. The PIBA 30 includes a stopper 32. The stopper includes an internal wall 44. The internal wall 44 defines the cavity 46. The cavity 46 is configured to catch the protrusion 22 such that the protrusion is disposed within the cavity 46. The internal wall 44 has a first depth, D1. Additionally, or alternatively, the first depth Di may be greater than the height Hn such that the neck 38 of the bottle 36 is spaced from removable cap 26 at the aperture 42 by the second depth D2 while the removable cap 26 is coupled with the neck 38 of the bottle 36. The length L1 is greater than or substantially equal to the sum of D1, D2, and T. In this context, substantially equal means that the protrusion 22 would not cause the PIBA 30 to rupture while the protrusion 22 is inserted through the aperture 42 with the actuator 48 engaging the removable cap 26; and simultaneously, while the protrusion 22 is caught by the cavity 46. If the protrusion 22 extends into the cavity 46 to puncture the stopper 32, the PIBA 30 being replaced cannot be used again. For example, if at least one thread of the plurality of threads 24 is twisted or driven into the stopper 32 a distance greater than D1, the PIBA 30 ruptures and the sealing nature of the PIBA 30, as described above, is diminished beyond the intended use.

With further reference to FIGS. 1 and 2B, the removable cap 26 may include the internal threading 28. The internal threading 28 allows for the removable cap 26 to twistably couple (e.g., rotationally couple) and decouple with the neck 38 of the bottle 36. The internal threading 28 may extend less than the entire internal depth Di as shown.

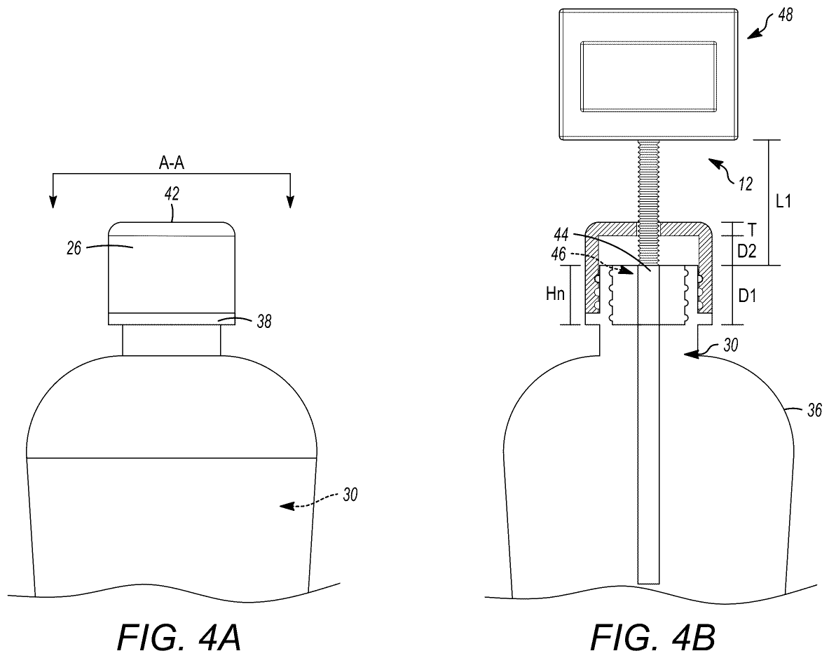

With reference to FIG. 4A, the method of removing the PIBA 30 starts with removing the manufactured cap from the neck 38 of the bottle 36. The manufactured cap (NOT SHOWN in FIG. 4A, shown in FIG. 1) is the cap the bottle 38 comes with from the distributor or manufacturer. After removing, or decoupling, the manufactured cap from the neck 38 of the bottle 36, the method includes coupling the removable cap 26 with the neck 38 of the bottle 36. The removable cap 26 is preferably coupled with the neck 38 of the bottle 36 by twisting the removable cap 26 so that the internal threading 28 engages the neck 38 to drive the removable cap 26 downward toward the bottle 36 until the removable cap 26 and the bottle 36 are as illustrated in FIG. 4A. The removable cap 26 acts as a fixed base to force the protrusion 22 into the PIBA aperture.

With reference to FIGS. 1 and 4B, the method of removing the PIBA 30 from the bottle 36 further includes inserting the protrusion 22 of the key 12 through the aperture 42 of the removable cap 26. Preferably, the protrusion 22 is inserted into the aperture 42 aligned with the central axis A. Inserting the protrusion 22 through the aperture 42 requires the key 12 to be translated downwardly toward the PIBA 30.

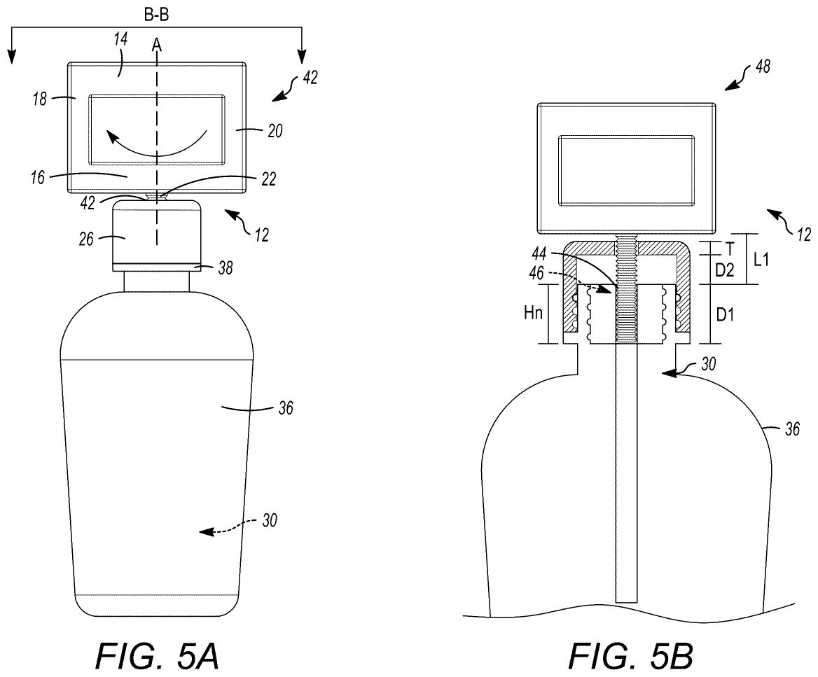

With reference to FIGS. 1 and 5A, the method of removing the PIBA 30 from the bottle 36 includes driving the actuator 48 of the key 12. In this context driving means, for example, rotating the actuator 48 of the key 12 about the central axis A so that the plurality of threads 24 apply a biasing force against the internal wall 44 to interlink the protrusion 22 with the internal wall 44 of the stopper 32. Further, driving in this context may additionally, or alternatively, mean translating the actuator 48 of the key 12 along the central axis A so that the plurality of threads 24 apply a biasing force against the internal wall 44 to interlink the protrusion 22 within the stopper body, e.g., through the internal wall 44 of the stopper 32. Driving the actuator 42 of the key 12 may be completed by the hand of the user. Additionally, or alternatively, driving of the actuator 42 of the key 12 may be completed by coupling the actuator 42 with a disc configured to be coupled with an electric motor, as shown in FIG. 3C, for example. The electric motor would then drive the actuator 42 of the key 12.

FIG. 5B-7, the plurality of threads 24 permanently deform the internal wall 44 such that the internal wall 44 defines a plurality of complimentary recesses that interlock between the plurality of threads 24, respectively. The plurality of complimentary recesses that interlock between the plurality of threads 24, respectively, assist the protrusion 22 to define the coupled (interlinked) relationship with the stopper 44 within the cavity 46. The actuator 48 is preferably driven toward the PIBA 30 until the breaker 16 engages the removable cap 26, as shown in FIG. 5B. Further, the actuator 48 is preferably driven toward the PIBA 30 until the protrusion 22 extends into the cavity 44 a distance substantially equal to D2. Substantially equal in this context means distance the protrusion 22 extends into the cavity 44 is within about 10% of the D2, within about 5% of the D2, or within about 1% of the D2.

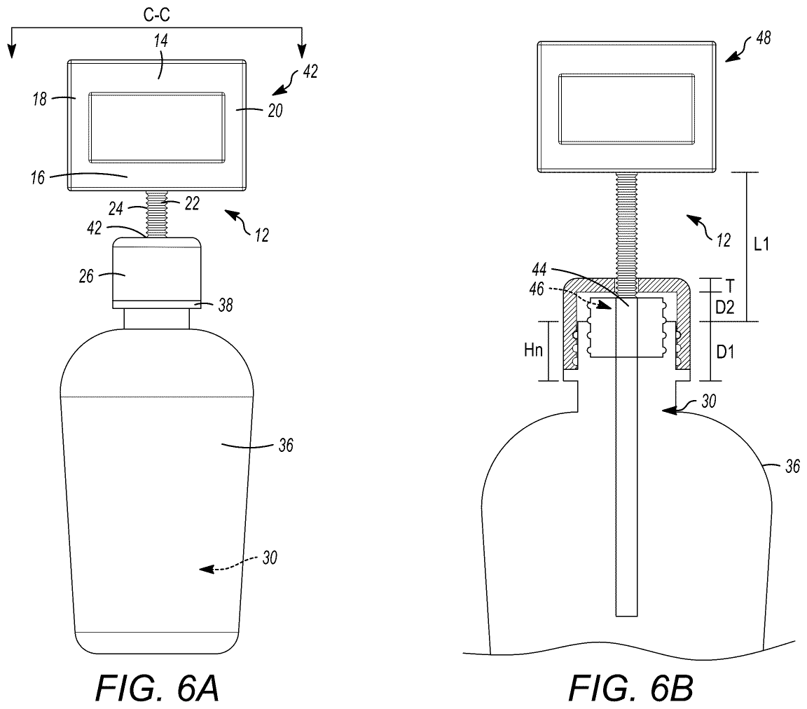

With reference to FIGS. 6A-6B, the method of removing the PIBA 30 from the bottle 36 includes displacing the actuator 48 of the key 12 away from the removable cap 26 until the PIBA 30 moves such that the PIBA 30 is essentially decoupled from the neck 38 of the bottle 36. For purposes of the present disclosure, the term “essentially decouple” indicates a PIBA as originally coupled with a bottle during a manufacturing process has become decoupled. Further, the term “essentially decouple” also means that the PIBA becomes no longer flush inside a neck of the bottle. However, “essentially decouple” does not necessarily mean the PIBA is spaced from the bottle 36 or the neck 38 of the bottle 36. In other words, a liquid inside the internal volume of the bottle could pass between the PIBA and the neck of the bottle after the PIBA is essentially decoupled from the bottle. Additionally, or alternatively, the method includes displacing the actuator 48 of the key 12 away from the removable cap 26 until the PIBA 30 fixed (interlinked) with the protrusion 22 of the key 12 at least partially moves from within the neck 38 of the bottle 36 into the removable cap 26.

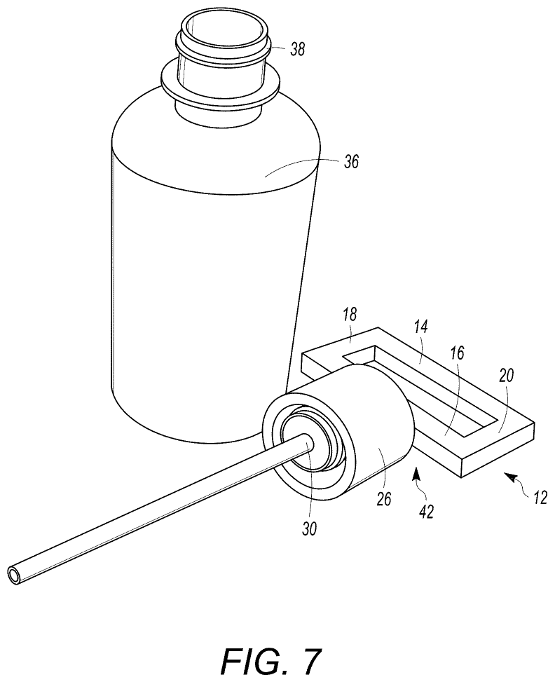

With reference to FIG. 7, the method of removing the PIBA 30 from the neck 38 of the bottle 30 includes decoupling the removable cap 26 from the neck 38 of the bottle 36 while the PIBA 30 is interlinked with the protrusion 22 to separate the PIBA 30 and removal tool 10 from the bottle 30. Preferably, decoupling the removal tool 10 and PIBA 30 from the bottle 36 is completed while the bottle 36 is in the upright position to prevent leakage of the liquid contained in the internal volume 40 of the bottle 36. Further, decoupling of the removable cap 26 from the neck 38 of the bottle 36 may include twisting the removable cap 26 opposite a direction the removable cap 26 was twisted to couple with the neck 38 of the bottle 36, while the bottle 36 remains static. Further, the distributor of the removal tool 10 may include a polymer package. The polymer package is configured to receive the removal tool 10 and PIBA 30. Additionally, or alternatively, the polymer package is configured to receive the removal tool 10 coupled with the PIBA 30 that was removed from the bottle 36. The polymer package closes and is substantially leak resistant such that any residue liquid remaining on or within the PIBA 30 remains within the polymer package through a shipping procedure.

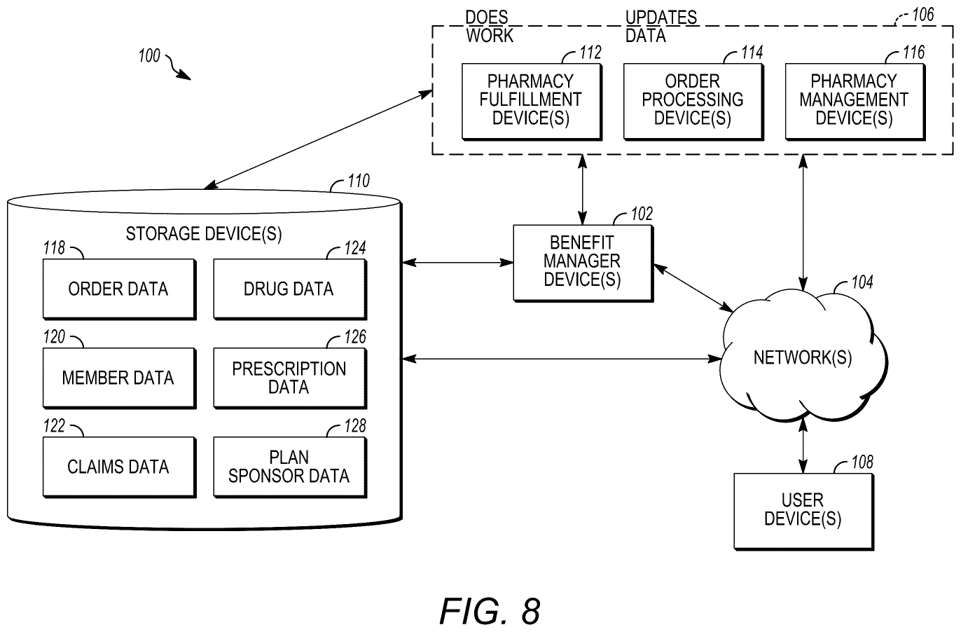

With reference to FIG. 8, the system 100 may include a benefit manager device 102, a pharmacy device 106, and a user device 108, which may communicate either directly and/or over a network 104. The system may also include a storage device 110.

The benefit manager device 102 is a device operated by an entity that is at least partially responsible for creation and/or management of the pharmacy or drug benefit. While such an entity operating the benefit manager device 102 is typically a pharmacy benefit manager (PBM), other entities may operate the benefit manager device 102 either on behalf of themselves, the PBM, another entity, or other entities. For example, the benefit manager device 102 may be operated by a health plan, a retail pharmacy chain, a drug wholesaler, a data analytics or other type of software-related company, or the like. In some embodiments, a PBM that provides the pharmacy benefit may also provide one or more than one additional benefit including a medical or health benefit; a dental benefit; a vision benefit; a radiology benefit; a pet care benefit; an insurance benefit; a long-term care benefit; a nursing home benefit; and the like. The PBM may, in addition to its PBM operations, operate one or more than one pharmacy.

Some of the operations of the PBM that operates the benefit manager device 102 may include the following activities and processes. A member (or a person on behalf of the member) of a pharmacy benefit plan administered by or through the PBM attempts to obtain a prescription drug at a retail pharmacy location (e.g., a location of a physical store) from a pharmacist or a pharmacist technician. The member may also attempt to obtain the prescription drug, or container filled with the liquid for example, through mail order drug delivery, from a mail order pharmacy location, which may be the system 100. In some embodiments, the member may also attempt to obtain the prescription drug, or removal tool 10 for example, directly or indirectly through the use of a machine, such as a kiosk, vending unit, mobile electronic device, or a different type of mechanical electrical, electronic communication device, and/or computing device. Such a machine may be filled with the prescription drug in prescription packaging, which may include multiple prescription components, prepared by the system 100.

A member may have a co-payment. The amount of the co-pay required form the member may vary with different pharmacy benefit plans having different plan sponsors or clients and/or prescription drugs. The member's copayment may be based on a flat copayment (e.g., $10), co-insurance (e.g., 10%), and/or a deductible (e.g., for first $500 of annual prescription drug expenses) for certain prescription drugs, certain types and/or classes of prescription drugs, and/or all prescription drugs. The copayment may be stored in the storage 110 or determined by the benefit manager device 102.

In conjunction with receiving the copayment (if any) from the member and dispensing the prescription drug to the member, the pharmacy submits a claim to the PBM for the prescription drug. After receiving the PBM (e.g., through the benefit manager device 102) may perform certain adjudication operations including verifying eligibility for the member, identifying and/or reviewing an applicable formulary for the member to determine any appropriate copayment, coinsurance, and deductible for the prescription drug, and performing a drug utilization review (DUR) on the member. The PBM provides a response to the pharmacy (e.g., from the benefit manager device 102 to the pharmacy device 106) following performance of at least some of the operations mentioned herein. For example, the PBM can route the prescription order to an automated pharmacy fulfillment system as described herein.

As part of the adjudication, a plan sponsor (or the PBM on behalf of the plan sponsor) ultimately reimburses the pharmacy for filling the prescription drug when the prescription drug was successfully adjudicated.

The aforementioned adjudication operations generally occur before the copayment is received and the prescription drug is dispensed. However, in some instances these operations may occur simultaneously, substantially simultaneously, or in a different order. In addition, more or less adjudication operations may be performed as at least part of the adjudication process.

The amount of reimbursement paid to the pharmacy by a plan sponsor and/or money paid by the member may be determined at least partially based on the type(s) of pharmacy network in which the pharmacy is included. Other factors may also be used to determine the amount in addition to the type of pharmacy network. For example, if the member pays the pharmacy for the prescription drug without the prescription drug benefit provided by the PBM (e.g., by paying cash without use of the prescription drug benefit or by use of a so-called pharmacy discount card offering other negotiated rates), the amount of money paid by the member may be different than when the member uses prescription or drug benefit. In some embodiments, the amount of money received by the pharmacy for dispensing the prescription drug and for the prescription drug itself may be higher than when the member uses the prescription or drug benefit. Some or all of the foregoing operations may be performed by executing instructions stored on the benefit manager device 102 and/or an additional device.

Examples of the network 104 include Mobile Communications (GSM) network, a code division multiple access (CDMA) network, 3^{rd} Generation Partnership Project (3GPP) network, an Internet Protocol (IP) network, a Wireless Application Protocol (WAP) network, a WiFi network, or an IEEE 802.11 standards network, as well as various combinations thereof. The network 104 may include an optical communication network. The network 104 may be a local area network or a global communication network, such as the Internet. In some embodiments, the network 104 may include a network dedicated to prescription orders, e.g., a prescribing network such as the electronic prescribing network operated by Surescripts of Arlington, Virginia.

Moreover, although the system shows a single network 104, multiple networks can be used. The multiple networks may communicate in series with each other to link the devices 102, 106-110 or in parallel to link the devices 102, 106-110.

The pharmacy device 106 may include an order processing device 114, a pharmacy manager device 116, and a pharmacy fulfillment device 112 in communication with each other directly and/or over the network 104. The pharmacy device 106 may include tracking device(s) embedded in at least one of the pharmacy fulfillment device 112, the order processing device 114, and the pharmacy manager device 116. The tracking device(s) may track the removal tool 10, the liquid-containing bottle 26, the PIBA 30, and the polymer package.

The order processing device 114 may receive information regarding a failed PIBA 30 in need of removal and replacement and may direct an order component to one or more than one of the devices of the pharmacy fulfillment device 112 at a pharmacy. Further, the order processing device 114 may receive information regarding the shipment of the removal tool 10 and the polymer package. The pharmacy fulfillment device 112 may fulfill, dispense, aggregate, and/or pack the order components of the prescription drugs, the bottle 26, the PIBA 30, and removal tool 10 for example, in accordance with one or more than one of the prescription orders directed by the order processing device 114. The order processing device 114 may be deployed in the system 100 or may otherwise be used. The removal tool 10, the liquid-containing bottle 26, the PIBA 30, and the polymer package can be tracked in the pharmacy fulfillment device 112 and/or the order processing device 114.

In general, the order processing device 114 is a device located within or otherwise associated with the pharmacy to enable fulfillment of a prescription and dispensing prescription drugs by the pharmacy fulfilment device 112. In some embodiments, the order processing device 114 may be an external device separate from the pharmacy and communicate with other devices located within the pharmacy.

For example, the external order processing device 114 may communicate with an internal order processing device 114 and/or other devices located within the system 100. In some embodiments, the external order processing device 114 may have limited functionality (e.g., as operated by a patient requesting fulfillment of a prescription drug), while the internal pharmacy order processing device 114 may have greater functionality (e.g., as operated by a pharmacist).

The order processing device 114 may track the prescription order as it is fulfilled by the pharmacy fulfillment device 112. The prescription order may include the removal tool 10, the liquid-containing bottle 26, the PIBA 30, and the polymer package to be filled by the pharmacy. The order processing device 114 may make pharmacy routing decisions and/or order consolidation decisions for the particular prescription order. The pharmacy routing decisions may include what device(s) in the pharmacy are responsible for filling or otherwise handling certain portions of the prescription order. The order consolidation decisions include whether portions of one prescription order or multiple prescription orders should be shipped together for a patient or a patient family. The order processing device 114 may also track and/or schedule literature or paperwork associated with each prescription order or multiple prescription orders that are being shipped together. The literature may include topics related to the use of the removal tool 10.

The pharmacy management device 116 may enable and/or facilitate management and operations in a pharmacy. For example, the pharmacy management device 116 may provide functionality to enable receipt and processing of prescription drug claims, management of pharmacy personnel, management of pharmaceutical and non-pharmaceutical products like the bottle 26, the PIBA 30, the removal tool 10, and the polymer package, track products in the pharmacy, record workplace incidents involve personnel and products, and the like. In some embodiments, the order processing device 114 may operate in combination with the pharmacy management device 116.

In some embodiments, the pharmacy management device 116 may be a device associated with a retail pharmacy location (e.g., exclusive pharmacy location, a grocery store with a retail pharmacy, or a general sales store with a retail pharmacy) or other type of pharmacy location at which a member attempts to obtain a prescription. The pharmacy management device 116 may be utilized by the pharmacy to submit the claim to the PBM (e.g., through the benefit management device 102) for adjudication.

In some embodiments, the pharmacy management device 116 may enable information exchange between the pharmacy and the PBM, for example, to allow the sharing of member information such as drug history, and the like, that may allow the pharmacy to better service a member (e.g., by providing more informed therapy consultation and drug interaction information, etc.). In some embodiments, the benefit manager 102 may track prescription drug fulfillment and/or other information for patients that are not members or have not identified themselves as members, at the time (or in conjunction with the time) in which they seek to have a prescription filled at a pharmacy.

The pharmacy fulfillment devices 112, the order processing device 114, and/or the pharmacy management device 116 may include circuitry, a processor, a memory to store data and instructions, and communication functionality. These devices 112-116, in some embodiments are dedicated to performing processes, methods and/or instructions described herein. Other types of electronic devices specifically configured to implement with the processes, methods and/or instructions described herein may also be used.

In some embodiments, at least some functionality of the order processing device 114 may be included in the pharmacy management device 116 may include circuitry, a processor, a memory to store data and instructions, and communication functionality. These devices 112-116, in some embodiments, are dedicated to performing processes, methods and/or instructions described herein. Other types of electronic devices specifically configured to implement with the processes, methods and/or instructions described herein may also be used.

In some embodiments, at least some functionality of the order processing device 114 may be included in the pharmacy management device 116. The order processing device 114 may be in a client-server relationship with the pharmacy management device 116, in a peer-to-peer relationship with the pharmacy management device 116, or in a different type of relationship with the pharmacy management device 116. The order processing device 114 and/or the pharmacy management device 116 may communicate directly (e.g., by utilizing a local storage) and/or through the network 104 (e.g., by utilizing a cloud configuration or software as a service, etc.) with the storage 110.

The user device 108 is used by a device operator. The device operator may be a user (e.g., an employee, a contractor, a benefit member, a patient of the pharmacy, or the like) associated with the system 100. Other device operators may also operate the user device 108. In some embodiments, the user device 108 may enable the device operator to attend to pharmacy operations in a convenient manner (e.g., remote from a pharmacy). In some embodiments, the user device 108 may enable the device operator to receive information about pharmacy processes, prescription drug fulfillment status, and the like. Further, the user device 108 can communicate with the network 104 to convey an incident related to the need for removal and replacement of the PIBA 30.

The user device 108 may be a stand-alone device that solely provides at least some of the functionality of the methods and systems or may be a multi-use device that has functionality outside off analysis of the methods and systems. In some embodiments, the computing system may include a mobile computing device. For example, the user device 108 may include a mobile electronic device, such as an iPhone or iPad by Apple, Inc., and mobile electronic devices powered by Android by Google, Inc. The user device 108 may also include other computing devices, such as desktop computing devices, notebook computing devices, netbook computing devices, gaming devices, and the like. Other types of electronic devices may also be used. The user device 108 running an application becomes a dedicated device when executing the application.

The storage device 110 may include: a non-transitory storage (e.g., memory, hard disk, CD-ROM, and the like) in communication with the benefit manager device 102, the pharmacy device 106, and/or the user device 108 directly and/or over the network 104. The non-transitory storage may store order data 118, member 120, claims data 122, drug data 124, prescription data 126, and/or plan sponsor 128. Further, the system 100 may include additional devices, which may communicate with each other directly or over the network 104.

The order data 118 may be related to a prescription order. The order data may include the type of the prescription drug (e.g., drug name and strength) and quantity of the prescription drug or items ordered such as the removal tool 10. The order data 118 may also include data used for completion of the prescription, such as prescription materials and/or the type and/or size of removal tool 10 for which the removal tool 10 can operate with. In general, prescription materials include an electronic copy of information regarding the prescription drug for inclusion with or otherwise provided (e.g., via email) in conjunction with the fulfilled prescription. The prescription materials may include electronic information regarding drug interaction warnings, recommended usage possible side effects, expiration date, date of prescribing, or the like. The order data 118 may be used by the pharmacy to fulfill a pharmacy order.

In some embodiments, the order data 118 includes verification information associated with fulfillment of the prescription in the pharmacy. For example, the order data 118 may include videos and/or images taken of (i) the bottle 26, removal tool 10, and the PIBA 30 prior to dispensing, during dispensing, and/or after dispensing, (ii) the container) used to contain the liquid prior to dispensing, during dispensing, and/or after dispensing, (iii) the packaging and/or packaging materials used to ship or otherwise deliver the prescription items prior to dispensing, during dispensing, and/or after dispensing, and/or (iv) the fulfillment process within the pharmacy or distributor. Other types of verification information, such as bar code data read from pallets, bins, trays, carts, and the like used to facilitate transportation of prescriptions within the pharmacy may also be stored as order data 118.

The member data 120 includes information regarding the members associated with the PBM. The information stored as member data 120 may include personal information, personal health information, protected health information, fitness data, health data, web and mobile app activity, and the like. Examples of the member data 120 include name, address, telephone number, e-mail address, prescription drug history, and the like. The member data 120 may include a plan sponsor identifier that identifies the plan sponsor associated with the member and/or a member identifier that identifies the member to the plan sponsor. The member data 120 may also include, by way of example, dispensation preferences such as type of label, type of cap, message preferences, language preferences, or the like.

The member data 120 may be accessed by various devices in the pharmacy to obtain information utilized for fulfillment and shipping of prescription orders. In some embodiments, an external order processing device 114 operated by or on behalf of a member may have access to at least a portion of the member data 120 for review, verification, or other purposes.

In some embodiments, the member data 120 may include information for persons who are patients of the pharmacy but are not members in a pharmacy benefit plan being provided by the PBM. For example, these patients may obtain drugs directly from the pharmacy, through a private label service offered by the pharmacy, or otherwise. In general, the use of the terms member (e.g., of a prescription drug benefit plan) and patient (e.g., of a pharmacy) may be used interchangeably in this disclosure.

The claims data 122 includes information regarding pharmacy claims adjusted by the PBM under a drug benefit program provided by the PBM for one, or more than one, plan sponsor. In general, the claims data 122 includes an identification of the client that sponsors the drug benefit program under which the claim is made, and/or the member that purchased the prescription drug giving rise to the claim, the prescription drug that was filled by the pharmacy (e.g., the national drug code number), the dispensing date, generic indicator, GPI number, medication class, the cost of the prescription drug provided under the drug benefit program, the copay/coinsurance amount, rebate information, and/or member eligibility, and the like. Additional information may be included.

In some embodiments, other types of claims beyond prescription drug claims may be stored in the claims data 122. For example, medical claims, dental claims, wellness claims, or other types of health care-related claims for members may be stored as a portion of the claims data.

In some embodiments, the claims data 122 includes claims that identify the members with whom the claims are associated. In some embodiments, the claims data 122 includes claims that have been de-identified (e.g., associated with a unique identifier but not with a particular, identifiable member), aggregated, and/or otherwise processed.

The drug data 124 may include drug name (e.g., technical name and/or common name), other names by which the drug is known by, active ingredients, an image of the drug (e.g., in pill form), and the like. The drug data 124 may include information associated with a single medication or multiple medications. The drug data 124 may include information associated with the bottle 26, the PIBA 30, the removal tool 10, and the packaging associated with the bottle 26, the PIBA 30, the removal tool 10.

The prescription data 126 may include information regarding prescriptions that may be issued by prescribers on behalf of patients, who may be members of the pharmacy benefit plan, for example to be filled by a pharmacy. Examples of the prescription data 126 include patient names, medication or treatment (such as lab tests), dosing information, and the like. The prescriptions may be electronic prescriptions, paper prescriptions that have been scanned, or otherwise. In some embodiments, the dosing information reflects a frequency of use (e.g., once a day, twice a day, before each meal, etc.) and a duration of use (e.g., a few days, a week, a few weeks, a month, etc.). In some embodiments, the prescription data 126 can be interpreted to reveal that sending the user a second unit of use device, the removal tool 10 and PIBA 30 for example, would be more efficient.

In some embodiments, the order data 118 may be linked to associated member data 120, claims data 122, drug data 124, and/or prescription data 126.

The plan sponsor data 128 includes information regarding the plan sponsors of the PBM. Examples of the plan sponsor data 128 include company name, company address, contact name, contact telephone number, contact e-mail address, and the like.

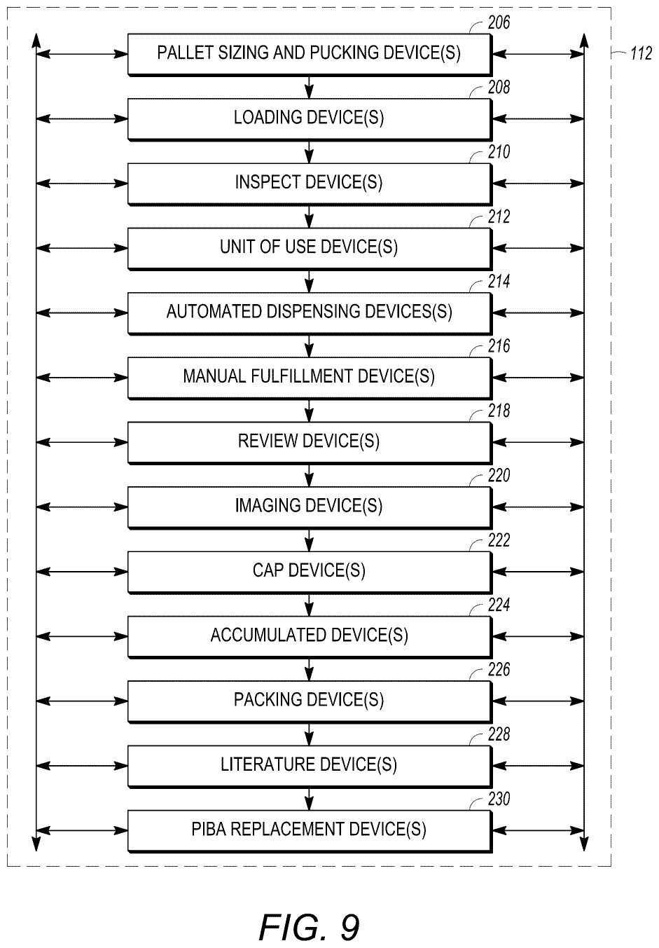

FIG. 9 illustrates the pharmacy fulfillment device 112, according to an example embodiment. The pharmacy fulfillment device 112 may be used to process and fulfill prescriptions and prescription orders. After fulfillment, the fulfilled prescriptions are packed for shipping.

The pharmacy fulfillment device 112 may include devices in communication with the benefit manager device, the order processing device 114, and/or the non-transitory storage 110, directly or over the network 104. Specifically, the pharmacy fulfillment device 112 may include pallet sizing and pucking device(s); loading device(s) 208; inspect device(s) 210, unit of use device(s) 212, automated dispensing device(s) 214, manual fulfillment device(s) 214, review device(s) 218, imaging device(s) 220, cap device(s) 222, accumulation device(s) 224, packing device(s) 226, and literature device(s) 228. Further, the pharmacy fulfillment device 112 may include additional devices, which may communicate with each other directly or over the network 104.

In some embodiments, operations performed by one or more of these devices 206-228 may be performed sequentially, or in parallel with the operations of devices as may be coordinated by the order processing device 114. In some embodiments, the order processing device 114 tracks a prescription with the pharmacy based on operations performed by one or more than one of the devices 206-228.

In some embodiments, the pharmacy fulfillment device 112 may transport prescription drug containers, for example, between more than one of the devices 206-228 in a high-volume fulfillment center, by use of pallets. The pallet sizing and pucking device 206 may configure pucks in a pallet. A pallet may be a transport structure for a number of prescription containers, and may include a number of cavities. A puck may be placed in one or more than one of the cavities in a pallet by the pallet sizing and pucking device 206. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 114 based on prescriptions that the order processing device 114 decides to launch. The arrangement logic may be implemented directly in the pallet sizing and pucking device 206. Once a prescription is set to be launched, a puck suitable for the appropriate size of container for that prescription may be positioned in a pallet by a robotic arm or pickers. The pallet sizing and pucking device 206 may launch a pallet once pucks have been configured in the pallet.

The loading device 208 may load prescription containers into the pucks on a pallet by a robotic arm, a pick and place mechanism, or the like. In one embodiment, the loading device 208 has robotic arms or pickers to grasp a prescription container and move it to and from a pallet or to and from a puck. The loading device may also print a label that is appropriate for a container that is to be loaded onto the pallet and apply the label to the container. The pallet may be located on a conveyor assembly during these operations (e.g., at the high volume fulfillment center or the like).

The inspect device 210 may verify that containers in a pallet are correctly labeled and in the correct spot on the pallet. The inspect device 210 may scan the label on one or more than one container on the pallet. Labels of containers may be scanned or imaged in full or in part by the inspect device 210. Such imaging may occur after the container has been lifted out of its puck by a robotic arm, picker, or the like, or may be otherwise scanned or imaged while retained in the puck. In some embodiments, images and/or video captured by the inspect device may be stored in the storage device as a portion of the order data 118.

The unit of use device 212 may temporarily store, monitor, label, and/or dispense unit of use products. In general, unit of use products are prescription drug products that may be delivered to a patient or member without being repackaged at the pharmacy. These products may include pills in a container, pills in a blister pack, inhalers, liquids in a spray or other dispensing container, and the like. Prescription drug products dispensed by the unit of use device 212 may be packaged individually or collectively for shipping or may be shipped in combination with other prescription drugs dispensed by other devices (e.g., in the high-volume fulfillment center).

At least some of the operations of the devices 206-228 may be directed by the other processing device 114. For example, the manual fulfillment device 216, the review device 218, the automated dispensing device 214, the packing device 226, and/or another device may receive instructions provided by the order processing device.

The automated dispensing device 214 may include one or more than one device that dispenses prescription drugs or pharmaceuticals into prescription containers in accordance with one or multiple prescription orders. In general, the automated dispensing device 214 may include mechanical and electronic components with, in some embodiments, software and/or logic to facilitate pharmaceutical dispensing that would otherwise be performed in a manual fashion by a pharmacist and/or pharmacist technician. For example, the automated dispensing device 214 may include high volume fillers (HVFs) that fill a number of prescription drug types at a rapid rate and blister pack machines that dispense and pack drugs into a blister pack. Prescription drugs dispensed by the automated dispensing devices 214 may be packaged individually or collectively for shipping or may be shipped in combination with other prescription drugs dispensed by other devices in the high volume fulfillment center. The automated dispensing device 214 may include a counter to count medications from a hopper and dispense to a specified container through a dispensing door structure to stage and to guide the drug items to the specified container.

The manual fulfillment device 216 may provide for manual fulfillment of prescriptions, the removal tool 10, the PIBA 30 to be replaced, and the polymer package. For example, the manual fulfillment device 216 may receive or obtain a container and enable fulfillment of the container by a pharmacist or pharmacy technician. In some embodiments, the manual fulfillment device 216 provides the filled container to another device in the pharmacy fulfillment devices 112 to be joined with other containers in a prescription order for a patient or member. In general, a manual fulfillment may include operations at least partially performed by a pharmacist or a pharmacy technician. For example, a person may retrieve a supply of the drug, the removal tool 10, replacement PIBA 30, and polymer package, may make an observation, may count out a prescribed quantity of drugs or items and place them into a prescription container, or the like. Some portions of the manual fulfillment process may be automated by use of a machine. For example, counting of capsules, tablets, or pills may be at least partially automated (e.g., through use of a pill counter or the like). Prescription drugs, the removal tool 10, the PIBA 30 to be replaced, and the polymer package dispensed by the manual fulfillment device 216 may be packaged individually or collectively for shipping or may be shipped in combination with other prescription drugs dispensed by other devices in the high-volume fulfillment center.

The review device 218 may process prescription containers to be reviewed by a pharmacist for proper prescription measurement, exception handling, prescription verification, and the like. Fulfilled prescriptions may be manually reviewed and/or verified by a pharmacist, as may be required by state or local law. A pharmacist or other licensed pharmacy person who may dispense certain drugs in compliance with local and/or other laws may operate the review device 218 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been cancelled, containers with defects, and the like. In an example embodiment, the manual review may be performed at the manual station.

The imaging device 220 may image containers prior to filling and/or after they have been filled with pharmaceuticals. The imaging device 220 may measure a fill height of the pharmaceuticals in the container based on the obtained image to determine if the container is filled to the correct height given the type of pharmaceutical. The images may be transmitted to the order processing device 114, and/or stored in the storage device 110 as part of the order data 118.

The cap device 222 may be used to cap or otherwise seal a prescription container or the bottle 36. In some embodiments, the cap device 222 may secure a prescription container with the manufactured cap or the removable cap 26 in accordance with a patient preference (e.g., a preference regarding child resistance, a preference regarding built-in adherence functionality, or the like), a plan sponsor preference, a prescriber preference, or the like. The cap device 222 may also etch a message into the manufactured cap or removable cap 26 or otherwise associate a message into the manufactured cap or removable cap 26, although this process may be performed by a different device in the high-volume fulfillment center.

The accumulation device 224 accumulates various containers of prescription devices in a prescription order. The accumulation device 224 may accumulate prescription containers from various devices or areas of the pharmacy. For example, the accumulation device 224 may accumulate prescription containers from the unit of use device 212, the automated dispensing device 214, the manual fulfillment device 216, and the review device 218, at the high-volume fulfillment center. The accumulation device 224 may be used to group the prescription containers prior to shipment to the member or otherwise. The accumulation device 224 may be used to group the removal tool 10 with the containers (or bottle 26) as well as with the PIBA 30 to be replaced and polymer package.

The literature device 228 prints, or otherwise generates, literature to include with prescription drug orders. The literature may be printed on multiple sheets of substrates, such as paper, coated paper, printable polymers, or combinations thereof. The literature printed by the literature device 228 may include information required to accompany the prescription drugs included in a prescription order, relating to prescription drugs in the order, financial information associated with the order (e.g., an invoice or an account statement, or the like).

In some embodiments, the literature device 228 folds or otherwise prepares the literature for inclusion with a prescription drug order (e.g., in a shipping container or the like). In some embodiments, the literature device 228 that prints the literature may be separate from the literature device that prepares the literature for inclusion with a prescription order.

The packing device 226, which is discussed in further detail below, packages prescription orders in preparation for shipping the order.

The pharmacy fulfillment device 112 in FIG. 9 may include single devices 206-228 or multiple devices 206-228 (e.g., depending upon implementation in a pharmacy). The devices 206-228 may be the same type or model of device or may be different device types or models. When multiple devices are present, the multiple devices may be of the same device type or models or may be a different device type or model. The types of devices 206-228 shown in FIG. 9 are example devices. In other configurations of the system 100, lesser, additional, or different types of devices may be included.

Moreover, multiple devices may share processing and/or memory resources. The devices 206-228 may be located in the same area or in different locations. For example, the devices 206-228 may be located in a building or a set of adjoining buildings. The devices 206-228 may be interconnected (e.g., by conveyors), networked, and/or otherwise in contact with one another or integrated with one another (e.g., at a high-volume fulfillment center), e.g., using a track on which shuttles move. In addition, the functionality of a device may be split among a number of discrete devices and/or combined with other devices.

The PIBA replacement device 230 may be in communication with the devices 206-228. The PIBA replacement device 230 may be located in the same area or in different locations. The PIBA replacement device 230 may robotically select the PIBA 30 to be replaced, the removal tool 10, and polymer package.

In various embodiments, the cap 26 mechanically engages the bottle and the key 12 engages the PIBA 30. The cap 26 does not directly engage the PIBA 30. The key 12 does not directly engage the bottle 36. In an operational example, the actuator 48 may contact the top wall of the cap 26 but does not contact the bottle 36 or the PIBA 30. The actuator 48 when engaged with the cap 26 during a PIBA removal operation is movable relative to the cap 26, and also the PIBA 30.

For ease of explanation, the present disclosure uses the term threads for the PIBA-engaging mechanisms. However, the present disclosure is not limited to continuous helical threads on the protrusion 22. Other PIBA-engaging structures are with the scope of the present disclosure, such as other types of radially outward projections. In an example, the helical threads can have intermittent breaks in the threads, e.g., the threads are not continuous. As illustrated in FIGS. 10 and 11, the PIBA-engaging structure can include a protrusion 22′, 22″ with the barbs 24′, 24″ that can either be arrow-shaped (as illustrated in FIG. 10) or hook-shaped (as illustrated in FIG. 11). In operation, the barbs 24′, 24″ have angled upward surfaces that allow the protrusion 22′, 22″ to pass downwardly into the through passage of the PIBA body and then dig into the body of the PIBA 30 when the direction of movement is reversed and the actuator 48 is pulled upwardly. The barb 24′ forms an acute angle with the protrusion upwardly toward the actuator 48. The barb 24′ forms an obtuse angle with the protrusion downwardly away from the actuator 48 and toward the free end of the cantilevered protrusion. In some other example embodiments, the protrusion 22 can be a bard bolt or a rag bolt. In an example, embodiment, the shank of the protrusion 22 can include irregular ribs extending outwardly therefrom. Irregular ribs can be irregular in placement around the outer surface of the shank, irregular in rib height, irregular in angle relative to the shank, irregular in shape (width or length), or other irregular patterns.

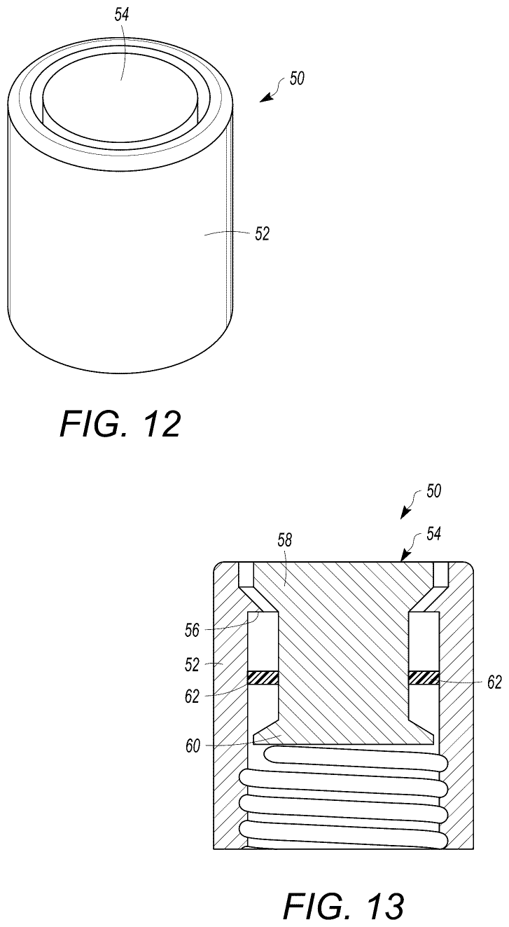

Turning now to FIGS. 12-15, another aspect of the present disclosure is related to a PIBA installation tool 50 or insertion tool for installing a new PIBA 30 into a bottle 36. The installation tool 50 includes a housing 52 and a plunger 54. The housing 52 has a generally cylindrical outer surface and an inner surface that surrounds a through-passage, which extends along the central axis A from a top of the housing 52 to a bottom of the housing 52. Adjacent the bottom of the housing 52, the inner surface has female threads that are configured to threadedly engage with the threads on the neck of the bottle 36. Adjacent the top of the housing 52, the inner surface has a radially inwardly extending projection with a shoulder 56 that faces axially towards the bottom of the housing 52. The housing 52 can be made of any suitable material, e.g., a plastic, glass, or metallic material. In the exemplary embodiment, the housing 52 is monolithic. However, in some other embodiments, the housing can be made as multiple pieces that are formed separately and are attached together.

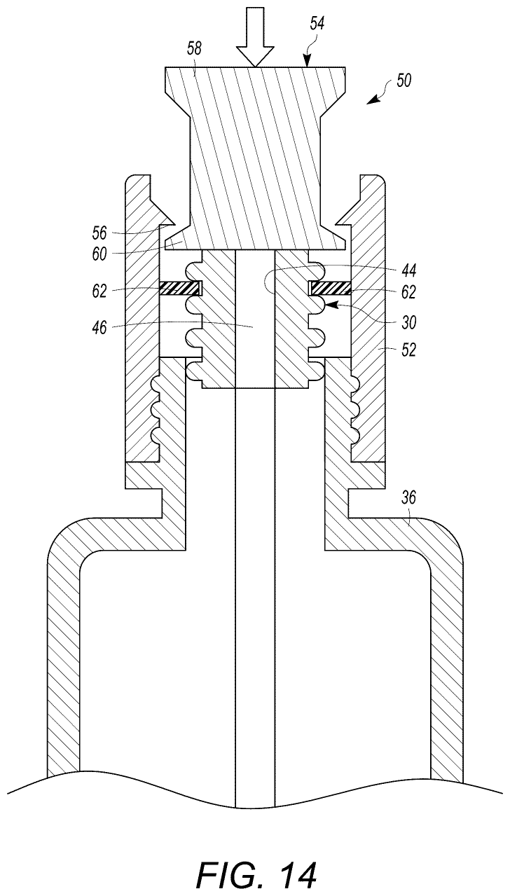

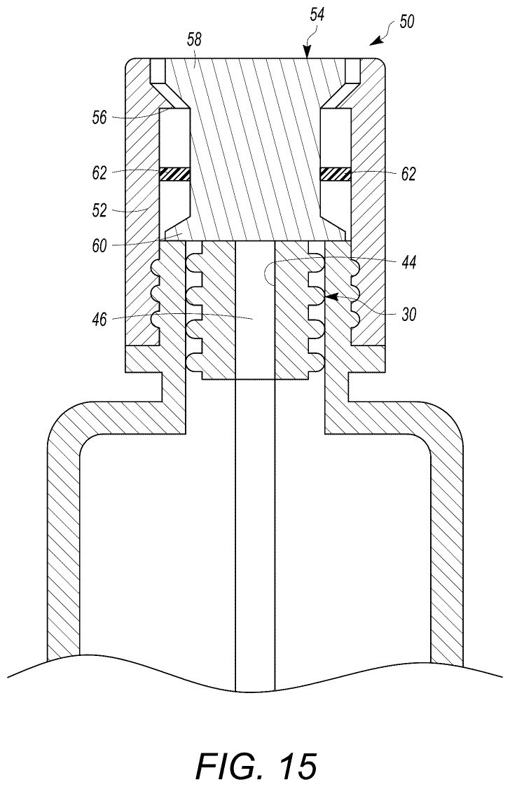

The plunger 54 is disposed in the through-passage of the housing 52 and is movable along the central axis A from a pre-install position, which is illustrated in FIG. 14 to an install position, which is illustrated in FIG. 15. The plunger 54 includes a cylindrical main body portion, a chamfered top portion 58 and a chamfered bottom portion 60. The chamfered portions 58, 60 are angled in opposite directions such that a top and a bottom of the plunger 54 have greater diameters than the main body portion. In an exemplary embodiment, the plunger 54 is made of two pieces with one of the chamfered portions 56 being formed separately from the remainder of the plunger 54 and attached (for example, with adhesives) thereto. In this embodiment, the piece of the plunger with the main body portion and the bottom chamfered portion 60 is inserted into the through passage of the housing 52 prior to attachment of the top chamfered portion 58 with the main body portion. In some other embodiments, the plunger can be made as a monolithic piece. As illustrated, the positioning of the shoulder 56 between the top and bottom chamfered portions 58, 60 effectively traps plunger 54 at least partially within the through passage of the housing 52.

Installation of a PIBA 30 into a bottle 36 using the installation tool 50 begins with threading the housing 52 into engagement with the bottle 36 and inserting a new PIBA 30 into the through-passage of the housing 52 through the bottom of the housing 52. In an exemplary embodiment, the inner surface of the housing 52 includes a plurality of bumps 62 or ribs that can temporarily hold the PIBA 30. In other words, the PIBA 30 can be pre-loaded into the through passage of the housing 52. The bumps 62 can be made of a different and more elastic material than the housing 52 to allow the PIBA 30 and the plunger 54 to pass by the bumps 62 during pre-loading and during installation of the PIBA 30 into the bottle 36.

Next, the plunger 54 is positioned in the pre-install position such that a majority of the plunger 54 projects out of the housing 52 through the top of the housing 52. As illustrated, in the pre-install position, the bottom chamfered portion 60 is in contact with the shoulder 56 of the housing 52.

A force is then applied by the user to a top surface of the plunger 54, and the plunger 54 guides the PIBA 30 along the central axis A and downwardly into the neck of the bottle 36. As illustrated in FIG. 15, the plunger 54 can be pushed downwardly until a bottom surface of the plunger 54 contacts a top surface of the bottle 36, at which point the PIBA 30 is properly installed in the bottle 36 with the top surface of the PIBA 30 being flush with the top of the bottle 36. The housing 52 can then be unthreaded from the bottle 36, and the PIBA 30 will remain properly positioned within the bottle 36.

With both of the removal and installation tools 10, 50, a user can remove an old, malfunctioning PIBA 30 from a bottle 36 and install a new PIBA 30 into the same bottle 36.

The above-described method embodiments can be performed in structures as described herein or stored in tangible machine-readable media. The above-described method embodiments and functionality instructions can be communicated over electronic systems and signals.

The preceding description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIG. 1 depicts one exemplary arrangement of elements, additional intervening elements, devices, features, or components may be present in an embodiment of the depicted subject matter.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

While at least one exemplary embodiment has been presented in the foregoing detailed description, it should be appreciated that a vast number of variations exist. For example, the above descriptions focus on liquid medication bottle-splitting systems and methods, however, the present disclosure could also be used to split non-medication liquids in some examples. In an additional example, non-medication liquids can be split using at least one of the methods or structures described herein. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. An apparatus for a bottle containing a liquid medicine, the apparatus comprising:
a removal tool including:
a removable cap configured to couple with the bottle, the removable cap defining an aperture therethrough;
a key including:
an actuator including:
a breaker selectively engaged with the removable cap;
a first side extension coupled with the breaker;
a second side extension spaced from the first side extension, the second side extension coupled with the breaker; and
a handle coupled with the first side extension and the second side extension, wherein the first side extension and the second side extension space the breaker from the handle; and
a protrusion coupled with the breaker, the protrusion including at least one radially outward projection, wherein the protrusion extends through the aperture of the removable cap; and
a press-in bottle adapter including:
a stopper including an internal wall defining a cavity configured to catch the protrusion of the key, wherein the radially outward projection of the protrusion engages the internal wall to engage the internal wall to interlink the protrusion and the stopper; and
an elongate tubular member coupled with the stopper, the elongate tubular member extending therefrom into the bottle.

2. The apparatus of claim 1, further including an insertion tool that is configured to install the press-in bottle adapter into the bottle, the insertion tool including:
a housing that includes a through passage and that is configured to be engaged with the bottle; and
a plunger that is at least partially received within the through passage of the housing and is configured to move relative to the housing and to press the press-in bottle adapter into the bottle.

3. The apparatus of claim 1, wherein the radially outward projection includes a plurality of threads that are oriented non-parallel with the breaker such that the actuator rotates about a central axis of the protrusion to drive the protrusion into the cavity of the stopper.

4. The apparatus of claim 3, wherein the plurality of threads permanently deform the internal wall of the stopper such that the internal wall defines a plurality of complimentary recesses that interlock between the plurality of threads, respectively.

5. The apparatus of claim 1, wherein the removable cap defines a funneled surface leading to the aperture.

6. The apparatus of claim 1, wherein the radially outward projection includes a plurality of threads that are oriented parallel with the breaker such that the actuator is translated toward the stopper to drive the protrusion through the aperture of the removable cap into the cavity of the stopper.

7. The apparatus of claim 1, wherein the radially outward projection includes a plurality of barbs.

8. The apparatus of claim 1, wherein the breaker has a first width, the handle has a second width, and the removable cap has a third width, wherein the first width is greater than the third width, and wherein the second width is greater than the third width.

9. The apparatus of claim 1, wherein the protrusion has a first length, the removable cap at the aperture has a thickness, the cavity has a first depth, and the stopper is spaced from the aperture by a second depth, and wherein the sum of first thickness, the first depth, and the second depth are substantially equal to the first length.

10. The apparatus of claim 1, wherein the protrusion has a first cross-sectional area large enough to be substantially flush with the removable cap within the aperture such that the removable cap with the protrusion disposed within the aperture of the removable cap is substantially leak resistant.

11. The apparatus of claim 1, wherein the actuator is rotated and translated manually.

12. A method comprising:
decoupling a manufactured cap from a neck of a bottle
coupling a removable cap defining an aperture with the neck of the bottle;
inserting a protrusion of a key into the aperture of the removable cap;
driving an actuator of the key toward a press-in bottle adapter until a breaker of the key engages the removable cap;
defining a coupled relationship between the protrusion and the stopper within a cavity of the stopper;
displacing the actuator of the key away from the removable cap until the press-in bottle adapter is essentially decoupled from the neck of the bottle; and
decoupling the removable cap from the neck of the bottle to remove the press-in bottle adapter and the removable cap from the bottle.

13. The method of claim 12, wherein the key has a first modulus of elasticity, wherein the press-in bottle adapter has a second modulus of elasticity, and further wherein the first modulus of elasticity is greater than the second modulus of elasticity.

14. The method of claim 13, further comprising:
prior to defining the coupled relationship, rotating the actuator of the key; and
deforming an internal wall of the stopper within the cavity with a radially outward projection of the protrusion to define a first plurality of complimentary recesses.

15. The method of claim 14, further comprising:
prior to decoupling the removable cap from the neck of the bottle, displacing the actuator of the key away from the removable cap until the press-in bottle adapter fixed with the key at least partially moves from within the neck of the bottle into the removable cap.

16. The method of claim 14, further comprising:
driving the actuator of the key toward the cavity of the stopper, the cavity having a second depth, until the protrusion having a first depth extends into the cavity a distance substantially equal to the second depth.

17. The method of claim 12, further including installing a new press-in bottle adapter into the neck of the bottle with an insertion tool, comprising the steps of:
inserting the new press-in bottle adapter into a through passage of a housing of the insertion tool;
coupling a housing of the insertion tool with the neck of the bottle; and
displacing a plunger of the insertion tool to urge the new press-in bottle adapter into the neck of the bottle.

18. An apparatus comprising:
a removal tool including:
a key including:
an actuator including a handle, the handle extending a first direction; and
a protrusion defining a plurality of threads, the protrusion coupled with the actuator, wherein the protrusion extends a second direction away from the handle, and wherein the first direction is non-parallel with the second direction; and
a removable cap defining an aperture centrally located therein, wherein the removable cap is configured to operably couple with a neck of a bottle.

19. The apparatus of claim 18, wherein an internal depth of the removable cap is at least equal to a neck height of the neck of the bottle configured to be operably coupled with the removable cap and a stopper height of a stopper of a press-in bottle adapter configured to be removed by the removal tool.

20. The apparatus of claim 18, wherein the actuator further includes:
a first side extension coupled with the handle, the first side extension extending outwardly from the handle; and
a second side extension coupled with the handle distal the first side extension, the second side extension extending outwardly from the handle, wherein the first side extension and the second side extension are engaged by at least one of a user and an electric motor to apply a torque to the key.
